(19) United States
(12) Patent Application Publication
(10) Pub. No.: US 2017/0347314 A1
(43) Pub. Date: Nov. 30, 2017

(54) POWER SAVING METHOD FOR ZIGBEE DEVICE

(71) Applicant: HON HAI PRECISION INDUSTRY CO., LTD., New Taipei (TW)

(72) Inventors: HUNG-YU PAN, New Taipei (TW); FU-YEN HSIEH, New Taipei (TW)

(21) Appl. No.: 15/605,949

(22) Filed: May 26, 2017

(30) Foreign Application Priority Data
May 28, 2016 (CN) 201610364674.9

(51) Int. Cl. H04W 52/02; H04W 4/00; H04W 84/18

(52) U.S. Cl. CPC H04W 52/028; H04W 4/008; H04W 4/001; H04W 84/18

(57) ABSTRACT

The present disclosure provides a Zigbee device, wherein a value of macBeaconOrder (BO) of a Zigbee protocol in the Zigbee device is set to 12, and a value of macSuperframeOrder (SO) of the Zigbee protocol in the Zigbee device is set to 6.

### CROSS-REFERENCE TO RELATED APPLICATIONS

This application claims priority to Chinese Patent Application No. 201610364674.9 filed on May 28, 2016, the contents of which are incorporated by reference herein.

### FIELD

The subject matter herein generally relates to power management, and particularly to a ZIGBEE device and a method of saving power.

### BACKGROUND

In December 2000, to meet requirements of wireless networking of small and low-cost equipments, the standards committee of institute of electrical and electronics engineers (IEEE approved the establishing of the task group 4 (TG4) to develop the standard of low-rate wireless personal area network (LR-WPAN), namely the IEEE802.15.4 protocol, or Zigbee technology. LR-WPAN has characteristics such as a simple construction, a low transmitting rate, a short communication distance, a low power dissipation, and a low cost. Zigbee technology is used in a lot of fields such as the industry control, traffic monitoring, and the medical detection. The most outstanding characteristic of LR-WPAN is the power saving. A Zigbee device may be able to work for several months or even a year without recharging, saving even more power for Zigbee device is still an issue.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a flow chart of an exemplary embodiment of a power saving method for a ZIGBEE device.

FIG. 2 illustrates an exemplary embodiment of a first Zigbee device communicating with a second Zigbee device.

FIG. 3 illustrates changes in battery level of the first Zigbee device of FIG. 2 based on data of a first experiment.

FIG. 4 illustrates changes in battery level of the first Zigbee device of FIG. 2 based on data of a second experiment.

FIG. 5 illustrates changes in battery level of the first Zigbee device of FIG. 2 based on data of a third experiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” exemplary embodiment in this disclosure are not necessarily to the same exemplary embodiment, and such references mean “at least one.”

Furthermore, the term “module”, as used herein, refers to logic embodied in hardware or firmware, or to a collection of software instructions, written in a programming language, such as, JAVA, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

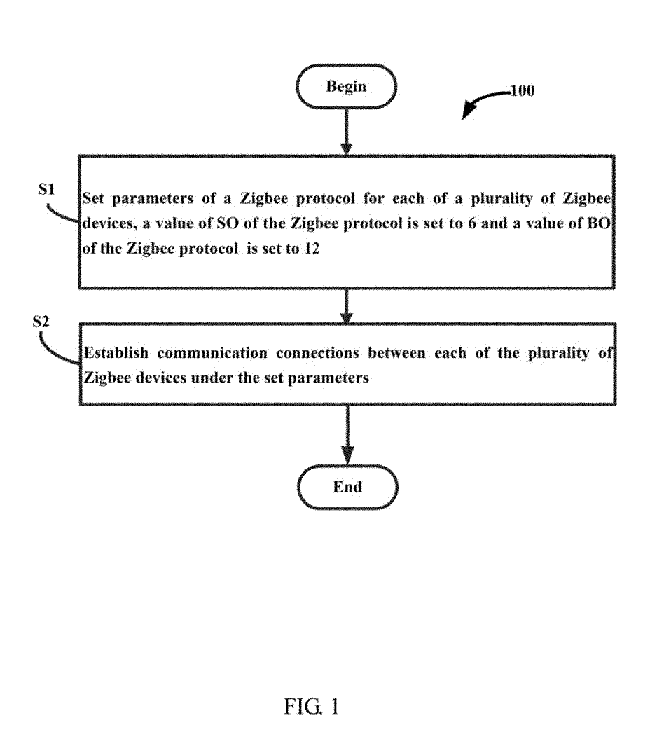

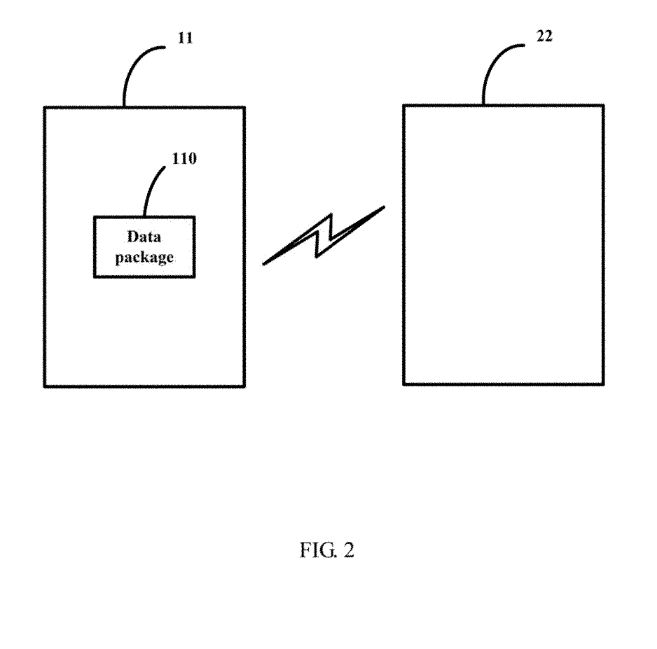

FIG. 1 illustrates an exemplary embodiment of a flowchart of a power saving method. The exemplary method 100 is provided by way of example, as there are a variety of ways to carry out the method. The method 100 described below can be carried out using the configurations illustrated in FIG. 2, for example, and various elements of these figures are referenced in explaining exemplary method 100. Each block shown in FIG. 1 represents one or more processes, methods, or subroutines, carried out in the exemplary method 100. Additionally, the illustrated order of blocks is by way of example only and the order of the blocks can be changed. The exemplary method 100 can begin at block S1. Depending on the exemplary embodiment, additional steps can be added, others removed, and the ordering of the steps can be changed.

At block S1, a number of Zigbee devices are set with parameters of a Zigbee protocol. In at least one exemplary embodiment, the plurality of Zigbee devices includes at least two Zigbee devices such as a first Zigbee device 11 and a second Zigbee device 22, as shown in FIG. 2. In at least one exemplary embodiment, the Zigbee device can be defined as an electronic device communicating with one or more other devices through the Zigbee protocol.

In at least one exemplary embodiment, each Zigbee device includes a Zigbee communication module, such that each Zigbee device can communicate with other Zigbee devices through the Zigbee protocol using the Zigbee communication module.

In at least one exemplary embodiment, the Zigbee device can be an intelligent household device that can be in electronic connection with a personal area network (PAN) coordinator using a star network structure, a tree network structure, or a mesh network structure.

In at least one exemplary embodiment, the Zigbee device can be an intelligent lamp.

In at least one exemplary embodiment, the Zigbee device can be a wireless sensor.

In at least one exemplary embodiment, the Zigbee device can be an alarm device.

It should be noted that the above examples for the Zigbee device are only for examples, and should not be limited.

In at least one exemplary embodiment, the parameters of the Zigbee protocol can include, but are not limited to, a value of macSuperframeOrder (hereinafter referred to as an “SO”), and a value of macBeaconOrder (hereinafter referred to as a “BO”).

In the Zigbee technology field, the Zigbee device controls a time length of an active period of the Zigbee device based on the value of SO and the value of BO. The Zigbee device controls a time length of an inactive period of the Zigbee device based on the value of BO. In other words, the value of SO can be used to control the time length of the active period of the Zigbee device. The value of BO can be used to control the time length of the active period of the Zigbee device and the time length of the inactive period of the Zigbee device.

In the Zigbee technology field, a relationship between the value of SO and the value of BO is 0≦SO≦BO≦14.

In at least one exemplary embodiment, the value of SO is set to 6 and the value of BO is set to 12.

By experiment on the part of Applicant, it is known that when the value of SO is set to 6 and the value of BO is set to 12, the Zigbee device minimizes energy consumption.

In at least one exemplary embodiment, the value of SO and the value of BO can be set when a programmer programs firmware code of the Zigbee communication module. In other words, before the firmware code is burnt into the Zigbee communication module, the value of SO can be preset to 6 and the value of BO can be preset to 12. Thus when the firmware code is burnt into the Zigbee communication module, the Zigbee communication module can work under a particular configuration, i.e., the value of SO being 6 and the value of BO being 12.

At block S2, a number of Zigbee devices establish communication connections therebetween under the set parameters, thus each Zigbee device works under the configuration, i.e., the value of SO is 6 and the value of BO is 12.

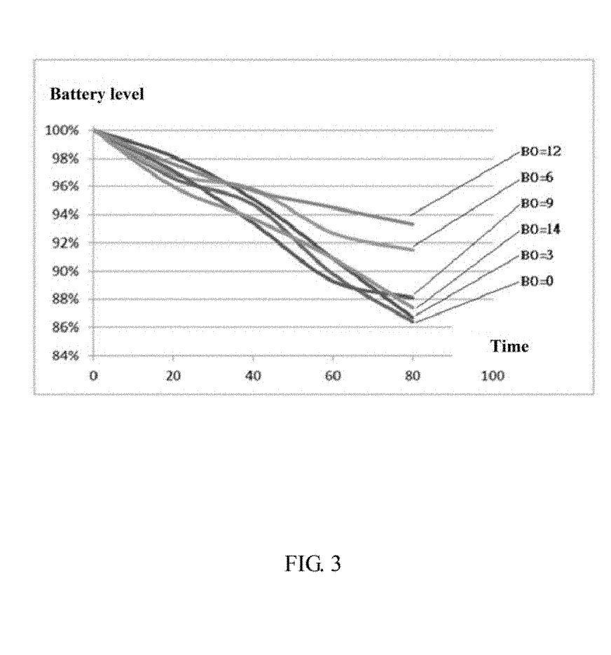

Referring to FIGS. 3-5, data from experiments proves that the energy consumption of the Zigbee device is minimized when the value of SO is set to 6 and the value of BO is set to 12.

In a first experiment: First, set the value of BO of the Zigbee protocol in the first Zigbee device 11 to be 0, other parameters of the Zigbee protocol in the first Zigbee device 11 are fixed. Second, the first Zigbee device 11 and the second Zigbee device 22 are fully charged, i.e., a battery level of each of the first Zigbee device 11 and second Zigbee device 22 approaches 100%. Third, the first Zigbee device 11 and the second Zigbee device 22 establish a communication connection, and the first Zigbee device 11 constantly sends a same data package 110 to the second Zigbee device 22. Fourth, current battery level of the first Zigbee device 11 is checked at 20 minute intervals. Over four times, i.e., when 80 minutes is past, the current battery level of the first Zigbee device 11 is read.

The above four steps are applied to obtain the current battery level of the first Zigbee device 11 when the value of BO in the first Zigbee device 11 is set to 3, then 6, then 9, then 12, and then 14.

FIG. 3 illustrates changes in the battery level of the first Zigbee device 11 when the value of BO of the Zigbee protocol in the first Zigbee device 11 is respectively set at 0, at 3, at 6, at 9, at 12, and at 14. FIG. 3 shows that, after 80 minutes, the current battery level of the first Zigbee device 11 when the value of BO of the Zigbee protocol in the first Zigbee device 11 is set to 12, and the current battery level of the first Zigbee device 11 when the value of BO of the Zigbee protocol in the first Zigbee device 11 is set to 6 are greater than the current battery level of the first Zigbee device 11 when the value of BO of the Zigbee protocol in the first Zigbee device 11 is set to any of 0, 3, 9, and 14. The value of BO set as 12 and 6 is clearly advantageous.

In a second experiment: First, the value of SO of the Zigbee protocol in the first Zigbee device 11 is set to 0, and other parameters of the Zigbee protocol in the first Zigbee device 11 are fixed. Second, the first Zigbee device 11 and the second Zigbee device 22 are fully charged, i.e., a battery level of each of the first Zigbee device 11 and second Zigbee device 22 approaches 100%. Third, the first Zigbee device 11 and the second Zigbee device 22 establish a communication connection, and the first Zigbee device 11 constantly sends the same data package 110 to the second Zigbee device 22. Fourth, current battery level of the first Zigbee device 11 is checked at 20 minute intervals. Over four times, i.e., when 80 minutes are past, lastly obtain the current battery level of the first Zigbee device 11.

Similarly, applying the above four steps, obtain the current battery level of the first Zigbee device 11 when the value of SO in the first Zigbee device 11 is respectively set at 3, at 6, at 9, at 12, and at 14.

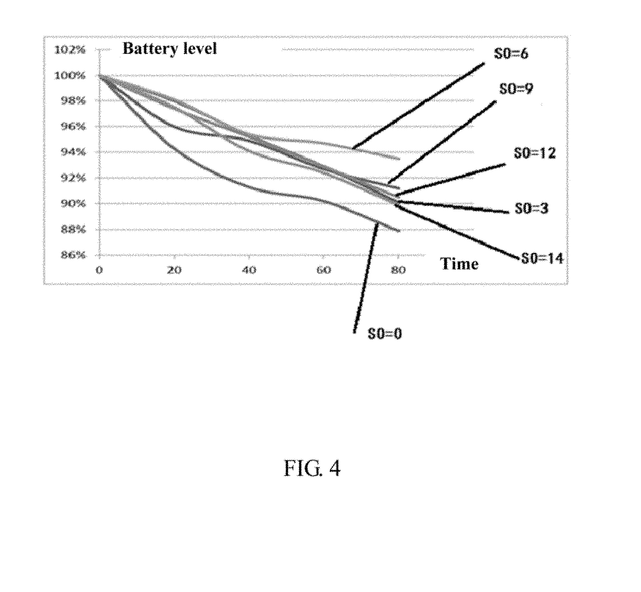

FIG. 4 illustrates changes in the battery level of the first Zigbee device 11 when the value of SO of the Zigbee protocol in the first Zigbee device 11 is respectively set at 0, at 3, at 6, at 9, at 12, and at 14. FIG. 4 shows that, after 80 minutes, the current battery level of the first Zigbee device 11 when the value of SO of the Zigbee protocol in the first Zigbee device 11 is set to 6, and the current battery level of the first Zigbee device 11 when the value of SO of the Zigbee protocol in the first Zigbee device 11 is set to 9 are greater than the current battery level of the first Zigbee device 11 when the value of SO of the Zigbee protocol in the first Zigbee device 11 is set to any of 0, 3, 12, and 14. The value of SO set at 6 and 9 is clearly advantageous.

It should be noted that the active period of a super frame can be ensured to be in a range of a beacon frame interval when SO is less than BO (i.e., SO<BO). Therefore, two parameter combinations can be obtained. One of the two parameter combinations is (BO=12, and SO=6), the other of the two parameter combinations is (BO=12, and SO=9).

Further experiments are described.

In a third experiment: First, the values of BO and SO of the Zigbee protocol in the first Zigbee device 11 are respectively set to 12 and 6, other parameters of the Zigbee protocol in the first Zigbee device 11 are unchanged. Second, the first Zigbee device 11 and the second Zigbee device 22 are fully charged, i.e., the battery level of each of the first Zigbee device 11 and second Zigbee device 22 approaches 100%. Third, the first Zigbee device 11 and the second Zigbee device 22 establish a communication connection, and the first Zigbee device 11 constantly sends the same data package 110 to the second Zigbee device 22. Fourth, current battery level of the first Zigbee device 11 is checked at 20 minute intervals. Over four times, i.e., when 80 minutes is past, check the current battery level of the first Zigbee device 11.

In the next, the value of BO and SO of the Zigbee protocol in the first Zigbee device 11 are set respectively to 12 and 9, other parameters of the Zigbee protocol in the first Zigbee device 11 are unchanged. Second, full charging of the first Zigbee device 11 and the second Zigbee device 22, i.e., the battery level of each of the first Zigbee device 11 and second Zigbee device 22 approaches 100%. Third, the first Zigbee device 11 and the second Zigbee device 22 establish a communication connection, and the first Zigbee device 11 constantly sends the same data package 110 to the second Zigbee device 22. Fourth, check current battery level of the first Zigbee device 11 at 20 minute intervals. Over four times, i.e., when 80 minutes is past, check the current battery level of the first Zigbee device 11.

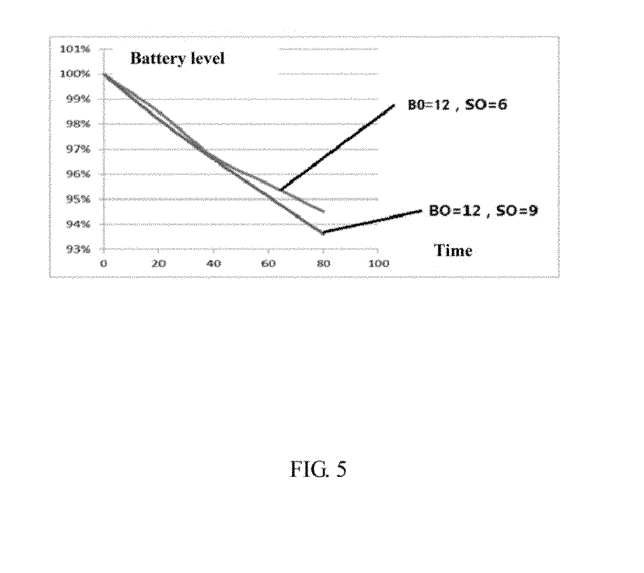

FIG. 5 illustrates the changes in battery level of the first Zigbee device 11 based on the data of the third experiment. FIG. 5 shows that, after 80 minutes, the current battery level of first Zigbee device 11 when the values of BO and SO are respectively set to 12 and 6, is greater than the current battery level of first Zigbee device 11 when the values of BO and SO are respectively set to 12 and 9. Therefore, the values of BO and SO of the Zigbee protocol in the first Zigbee device 11 should be set to 12 and 6 respectively to minimize power consumption.

It should be emphasized that the above-described exemplary embodiments of the present disclosure, including any particular exemplary embodiments, are merely possible examples of implementations, set forth for a clear understanding of the principles of the disclosure. Many variations and modifications can be made to the above-described exemplary embodiment(s) of the disclosure without departing substantially from the spirit and principles of the disclosure. All such modifications and variations are intended to be included herein within the scope of this disclosure and protected by the following claims.

What is claimed is:

1. A Zigbee device, wherein a value of macBeaconOrder (BO) of a Zigbee protocol in the Zigbee device is set to 12, and a value of macSuperframeOrder (SO) of the Zigbee protocol in the Zigbee device is set to 6.

2. The Zigbee device according to claim 1, wherein the Zigbee device is an intelligent lamp.

3. The Zigbee device according to claim 1, wherein the Zigbee device is a wireless sensor.

4. The Zigbee device according to claim 1, wherein the Zigbee device is an alarm device.

5. A power saving method applied to a Zigbee device, comprising:
setting parameters of a Zigbee protocol in the Zigbee device, wherein the parameters comprise a value of macBeaconOrder (BO) of the Zigbee protocol and a value of macSuperframeOrder (SO) of the Zigbee protocol, wherein the value of BO is set to 12, and the value of SO is set to 6.

6. A power saving method applied to a plurality of Zigbee devices, comprising:
setting parameters of a Zigbee protocol in each of the plurality of Zigbee devices, wherein the parameters comprise a value of macBeaconOrder (BO) of the Zigbee protocol and a value of macSuperframeOrder (SO) of the Zigbee protocol, wherein the value of BO is set to 12, and the value of SO is set to 6; and
establishing communication connections between the plurality of Zigbee devices under the set parameters.

7. The method according to claim 6, wherein each of the plurality of Zigbee devices is in electronic connection with a personal area network (PAN) coordinator using a star network structure, a tree network structure, or a mesh network structure.

8. The method according to claim 6, wherein the value of SO is used to control a time length of an active period of the Zigbee device.

9. The method according to claim 6, wherein the value of BO is used to control a time length of an active period of the Zigbee device, and a time length of an inactive period of the Zigbee device.

10. The method according to claim 6, wherein the plurality of Zigbee devices comprises at least two Zigbee devices.
